(19) United States
(12) Patent Application Publication
(10) Pub. No.: US 2011/0119390 A1
(43) Pub. Date: May 19, 2011

(54) SELECTIVELY RE-MAPPING A NETWORK TOPOLOGY

(76) Inventors: Phillip A. Leech, Houston, TX (US); Dennis Baker, Houston, TX (US)

(21) Appl. No.: 13/054,078

(22) PCT Filed: Jul. 31, 2008
(86) PCT No.: PCT/US2008/071838

§ 371 Date: Jan. 13, 2011

(51) Int. Cl. G06F 15/16

(52) U.S. Cl. 709/228

(57) ABSTRACT

In at least some embodiments, a method includes receiving a remote computing session request. The method further includes inspecting a user profile based on the remote computing session request and selectively re-mapping a network topology based on information in the user profile.

### BACKGROUND

Computer networks are formed by linking a plurality of computers together (e.g., via hardware and software) for the purpose of sharing data The size and scope of computer networks vary. Regardless of the size and scope, a network's topology represents the network's layout or structure from the point of view of data flow. For example, in a “bus” network, all of the computers share data across a common conduit. In contrast, in a “star” network, all data flows through one centralized device. Various types of network topologies exist. Further, network topologies can be fixed or dynamic. Changing a network topology often involves substantial administrative time and effort. Improvements to networking methods and systems are desirable.

### BRIEF DESCRIPTION OF THE DRAWINGS

For a detailed description of exemplary embodiments of the invention, reference will now be made to the accompanying drawings in which:

FIG. 1 shows a computer network architecture in accordance with embodiments of the disclosure;

FIGS. 2A-2D show a network having a configurable topology in accordance with embodiments of the disclosure;

FIG. 2E-2F show alternative features of the network of FIGS. 2A-2D;

FIG. 3 shows a session-based network in accordance with embodiments of the disclosure;

FIG. 4 shows a Remote Computing Solution (RCS) architecture in accordance with embodiments of the disclosure;

FIG. 5 shows a remote session administrator interface in accordance with embodiments of the disclosure;

FIG. 6 shows a remote session client interface in accordance with embodiments of the disclosure; and

FIG. 7-8 show methods in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function, In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention enable a network topology to be customized at the time a user logs onto a network or requests a virtual desktop session. As used herein, the term “network topology” refers to the configuration of real and/or virtual network components (e.g., switches or routers) to enable client computers to access computing resources. In at least some embodiments, customizing the network topology involves remapping Virtual Local Area Networks (VLANs) to switch port assignments. For example, when a user logs onto a network, software can determine which VLANs the user can access. If the intended computing resource is already configured with the appropriate network infrastructure (e.g., VLANs and/or switch ports), no customization is needed. Otherwise, the VLANs and switch ports are re-mapped for the user. Once the re mapping is complete, the user is directed to the desired computing resource.

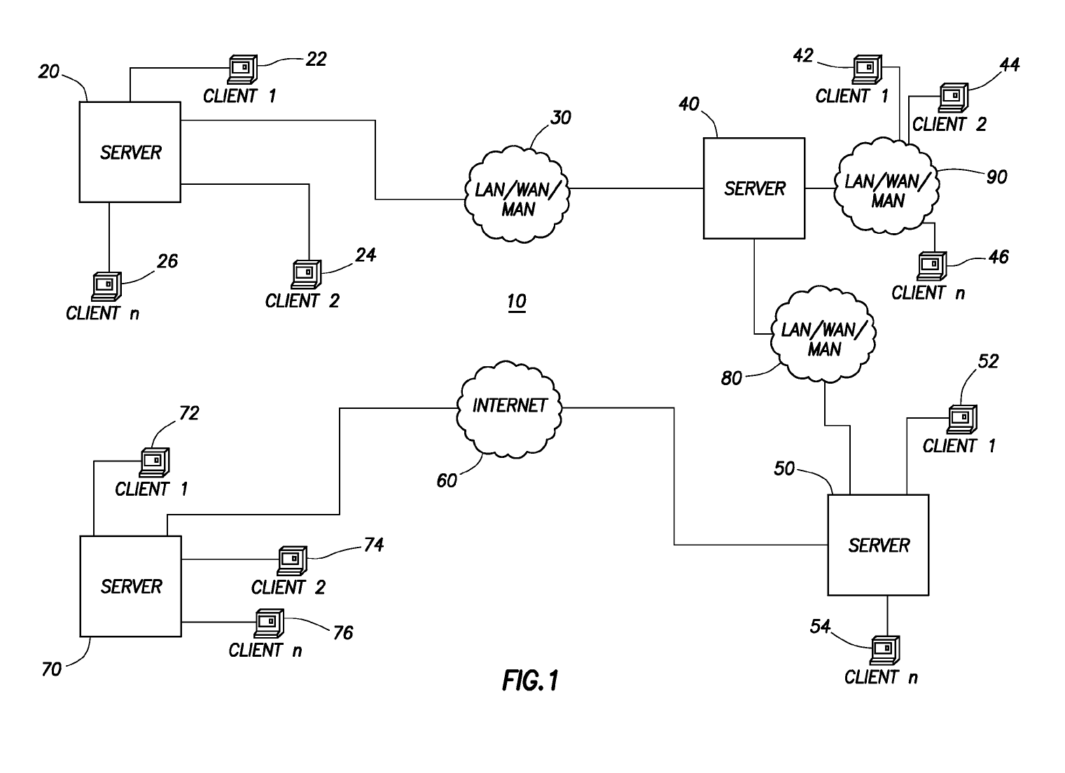

Turning now to the drawings and referring initially to FIG. 1, a block diagram of a computer network architecture 10 is illustrated. As shown, a server 20 is connected to a plurality of client computers 22, 24 and 26. The server 20 may be connected to as many as n different client computers. Each client computer in the network 10 may be a fully functional client computer. The magnitude of n may be a function of the computing power of the server 20. If the server 20 has large computing power (for example, faster processor(s) and/or more system memory), it may be able to effectively serve a large number of client computers.

The server 20 couples to a network infrastructure 30, which may include any combination of hubs, switches, routers, and the like. While the network infrastructure 30 is illustrated as being either a local area network (“LAN”), a wide area network (“WAN”) or a municipal area network (“MAN”), those skilled in the art will appreciate that the network infrastructure 30 may assume other forms or may even provide network connectivity through the Internet. As will be described, the network 10 may include other servers, which may be widely dispersed geographically with respect to the server 20 and to each other to support client computers in other locations.

The network infrastructure 30 couples the server 20 to server 40, which may be representative of any other server in the network environment of server 20. The server 40 may couple to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. The server 40 is additionally connected to server 50, which is in turn connected to client computers 52 and 54. In at least some embodiments, the servers 40 and 50 are connected via a network infrastructure 80, which may include a LAN, a WAN, a MAN or other network configuration. Although the client computers 52 and 54 are shown connecting directly to the server 50, the client computer 52 and 54 may alternatively be connected to server 50 via a LAN, a WAN, a MAN or other network configuration. The number of client computers connected to the servers 40 and 50 may be dependent on the computing power of the servers 40 and 50, respectively.

The server 50 may additionally be connected to the Internet 60, which may in turn be connected to a server 70. The server 70 may be connected to a plurality of client computers 72, 74 and 76. The server 70 may be connected to as many client computers as its computing power will allow. Those of ordinary skill in the art will appreciate that the servers 20, 40, 50, and 70 may not be centrally located. Further, in alternative embodiments, multiple LANs may be connected via the Internet 60 as well.

In at least some embodiments, users of the various clients in the network 10 are able to request “computing resource sessions.” As used herein, computing resource sessions refer to login sessions in which a user-controlled client remotely accesses processing and/or storage capabilities of the network 10. At the time a login occurs, a session allocation server (e.g., one of the servers 20, 40, 50 or 70) inspects a database that stores user access rights or user preferences for computing resource sessions. As needed, the network's topology is automatically updated based on user access rights or user preferences,

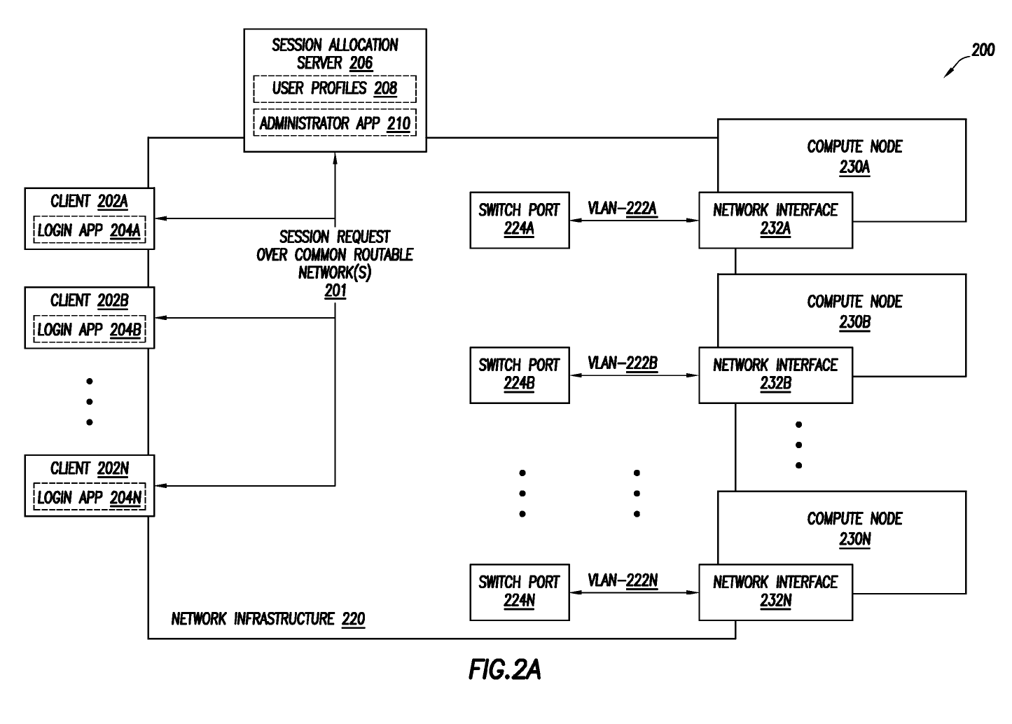

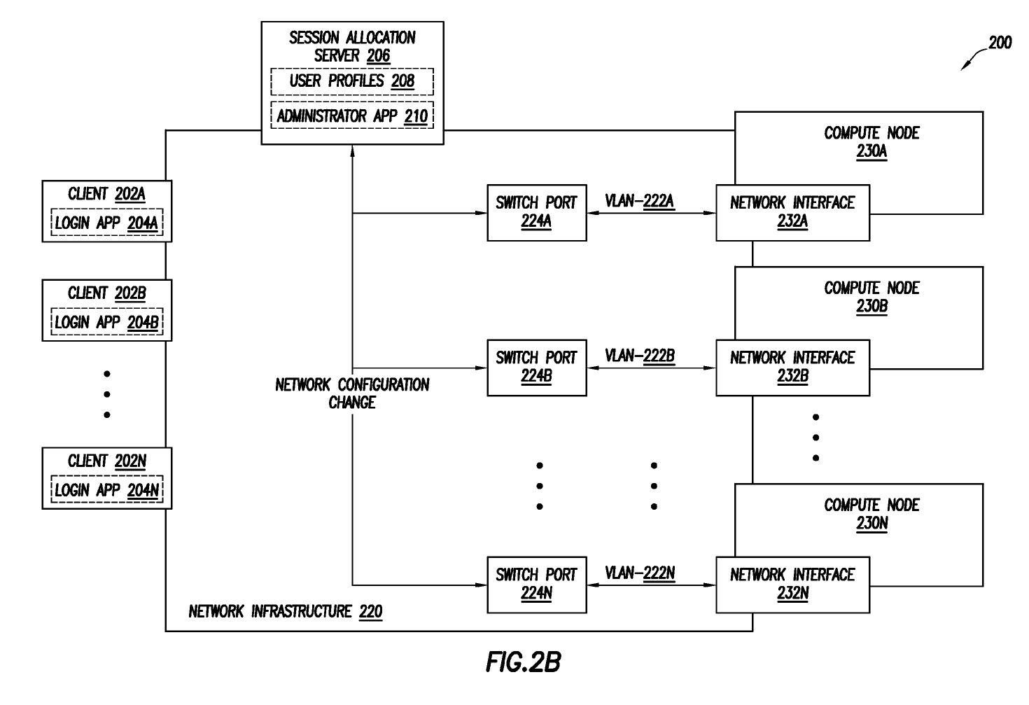

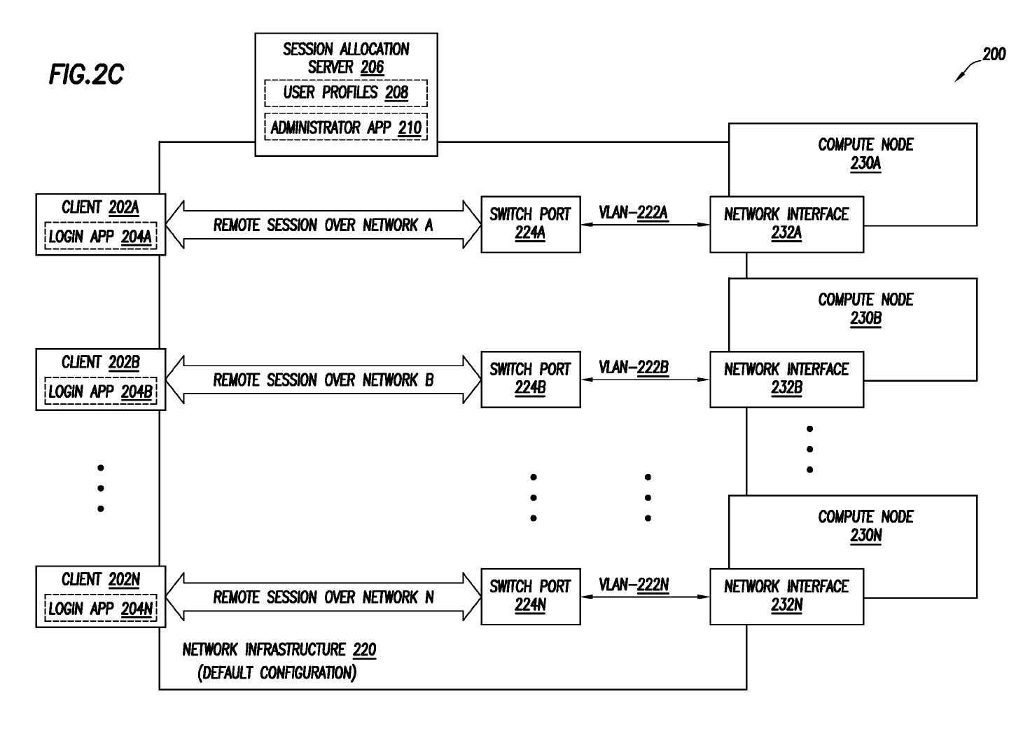

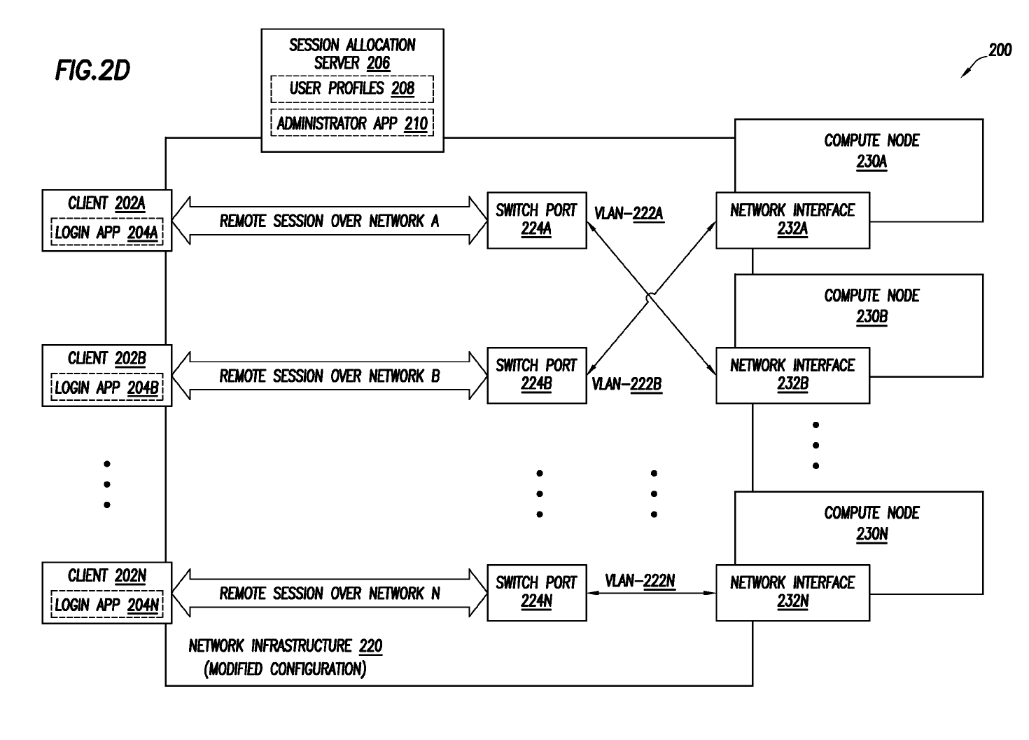

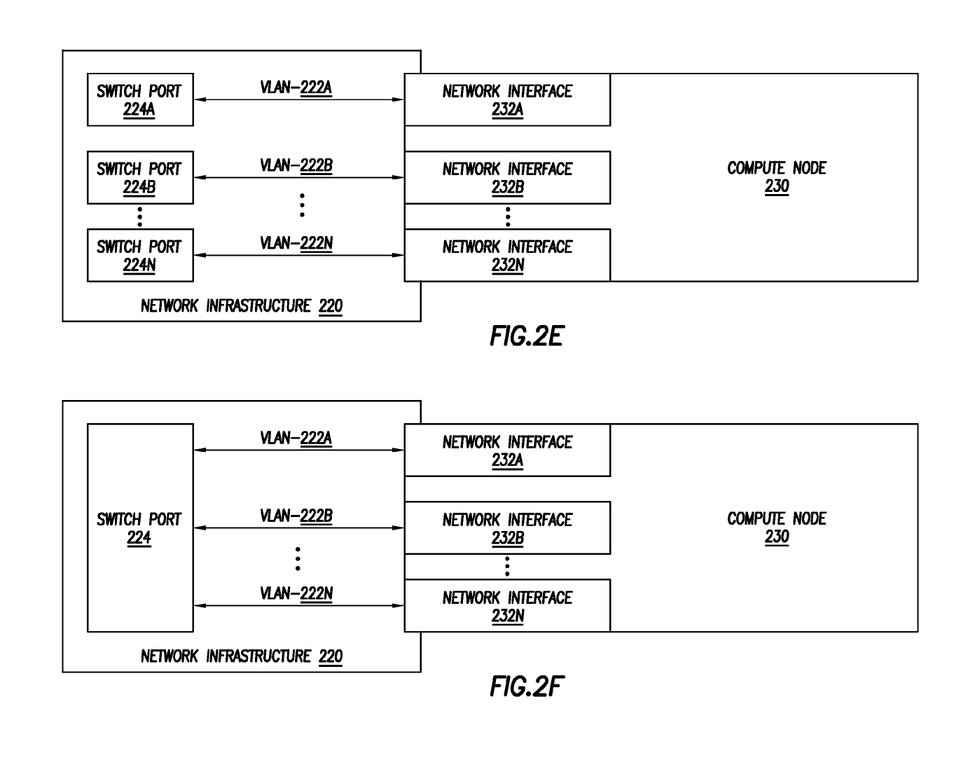

FIGS. 2A-2D show a network 200 having a configurable topology in accordance with embodiments of the invention. As shown, the network 200 comprises a plurality of clients 202A-202N that couple to compute nodes 230A-230N via a network infrastructure 220. In embodiments in which VLANs are supported, the network infrastructure 220 represents one or more VLAN-capable devices. The compute nodes of the network 200 may be either physical or virtual.

In FIG. 2A, users are able to submit a session request to a session allocation server 206 through an appropriate login or session request application 204A-204N executed by each client 202A-202N. In FIG. 2B, the session allocation server 206 responds to a session request by determining which compute node 230A-230N to allocate to the user based on information provided in user profiles 208 stored by (or accessible to) the session allocation server 206. In the embodiment of FIGS. 2A-2D, each user profile 208 may store information such as which VLAN(s) the user may access as well as detailed instructions on how the user's resource should be configure to facilitate user connectivity to said VLAN(s). The user profiles 208 may also contain other useful information such as user access rights, user roles (e.g., employee, engineer, marketing), user preferences or other information. An administrator application 210 executed by the session allocation server 206 enables an administrator to control user access rights, user roles, and other features related to the session allocation server. The administrator application 210 also may enable an administrator to limit user preferences (e.g., a user may only request up to a predetermined amount of computing resources).

To allocate the compute nodes 230A-230N to the clients 202A-202N, the VLANs 222A-222N supported by the network infrastructure 220 are associated with the switch ports 224A-224N. In at least some embodiments, each client 202A-202N can belong to at least one of the VLANs 222A-222N. VLAN technology allows network administrators to separate logical networks from physical networks. This concept is different from a traditional Local Area Network (LAN) in that a LAN is limited by its physical connectivity. All users in a LAN belong to a single broadcast domain and can communicate with each other at the Data Link Layer or “Layer 2.” Network managers have used VLANs to segment a complex network into smaller units for better manageability, improved performance, and security. For example, network managers may use one VLAN for each IP subnet in their network. Communication between subnets is made possible at the Network Layer or “Layer 3,” using Internet Protocol (IP) routers. In accordance with embodiments, a LAN can be thought of as a single physical network that has been logically divided into discrete VLANs that can operate independently of each other.

In a VLAN architecture, physical isolation is not required to define broadcast domains. Switch ports that are part of the same VLAN can communicate with each other at the Data Link Layer. Also, the physical location of clients does not define its LAN boundary. A client can be physically moved from one switch port to another without losing its “view” of the network as long as the other switch port is on the same VLAN. In other words, the set of clients it can communicate with at the Data Link Layer remains the same, provided that its VLAN membership is also migrated from port to port upon relocation. By reconfiguring the VLAN membership of the switch port a client is attached to, the network view of the client is easily changed without requiring a physical move from port to port. The benefits of VLAN include bandwidth preservation, manageability, and enhanced security. Bandwidth preservation is improved by restricting broadcast and multi-cast traffic to only those clients listening to and responding to the traffic related to the corresponding VLAN. Manageability is improved because moves, additions, and changes to network topology do not require physical changes to network topology. Also, physically dispersed work groups can be logically connected within the same broadcast domain to appear as if they are on the same physical LAN. A single physical link can simultaneously serve several IP subnets when subnet-based VLANs are configured on that link. Clients using VLANs can offer some Class of Service (CoS) locally by prioritizing traffic for certain activities. Security is enhanced because different security domains can be constructed for the network with greater flexibility. Since frames are passed to a destination port only if the port belongs to the same VLAN as the frame, VLANs help enforce traffic isolation providing greater security.

To implement VLAN networks, the network infrastructure 220 follows a set of rules. In at least some embodiments, upon receiving a broadcast or multicast frame from a port, the network infrastructure 220 floods the frame only to those ports that belong to the same VLAN as the frame. Upon receiving a unicast frame, the network infrastructure 220 forwards the frame to the port to which the frame is addressed only if the port belong to the same VLAN as the frame. A unique number called the VLAN identifier (ID) identifies each VLAN. In at least some embodiments, the VLAN ID is a 12-bit field which would support up to 4095 discrete VLANs in a typical network.

In at least some embodiments, the network infrastructure 220 associates frames with one or more VLANs based on attributes of the frame (e.g., Ethernet and IP header content). Example attributes include a destination Media Access Control (MAC) address, an IP address, a Transmission Control Protocol (TCP) port, a Network Layer protocol, or other attributes. Attributes such as the switch port on which the frame arrived can also be used. In other words, if configured to do so, a switch can implicitly assign a VLAN ID to all frames arriving on a given port. Also, a frame can carry explicit VLAN information in a tag that that is added to the Ethernet header.

In at least some embodiments, the network infrastructure 220 can be configured (e.g., by the session allocation server 206) to add ports to a VLAN group or groups. For example, the network infrastructure 220 and/or the session allocation server 206 may maintain a list of ports 224A-224N that belong to each VLAN 222A-222N enabled in the network infrastructure 220. Also, the network infrastructure 220 and/or the session allocation server 206 may maintain a list of the VLANs 222A-222N enabled for each of the ports 224A-224N.

The network infrastructure 220 can vary with different embodiments. In some embodiments, the port on which a frame arrives determines the VLAN membership of the frame. In such embodiments, only one VLAN per switch port is supported unless VLAN tagging is used as understood by those of skill in the related art. In alternative embodiments, the network infrastructure 220 supports VLAN membership rules based on frame content such as MAC address, TCP/UDP port information, IP address or other content. In alternative embodiments, the network infrastructure 220 supports VLAN membership rules based on a VLAN tag found in the frame content. Additionally or alternatively, the network infrastructure 220 performs the function of Layer 3 (e.g., IP routing) in addition to VLAN classification.

In at least some embodiments, the session allocation server 206 customizes the network infrastructure 220, including the VLANs 222A-222N and the switch ports 224A-224N to connect clients 202A-202N to the appropriate compute nodes 230A-230N. The compute nodes 230A-230N may each have at least one communication port 232A-232N as shown. In some embodiments, each compute node 230A-230N only supports one user at a time. Alternatively, some or all of the compute nodes 230A-230N can support multiple users simultaneously.

In at least some embodiments, the compute nodes 230A-230N represent computing resources that are part of an Remote Computing Solution (RCS) architecture as will later be described. In various embodiments, some or all of the compute nodes 230A-230N are virtualized to provide processing and storage capabilities. To support virtualization, the compute nodes 230A-230N may implement a virtual machine operating system (OS) (e.g., VMWare) hosting one or more virtual client Operating Systems. In accordance with embodiments, each virtual machine and/or each virtual client OS is treated as an independent compute node 230A-230N. The allocation server 206 would configure the switch port that the compute resource is either physically or virtually connected.

In accordance with some embodiments, the network infrastructure 220 has a default configuration. As an example, FIG. 2C illustrates when remote sessions between the clients 202A-202N have been set up with the compute nodes 230A-230N in network infrastructure's default configuration. In such case, the session allocation server 206 can allocate a remote session without changing the network infrastructure 220. In at least some embodiments, the default configuration is taken into account as part of the session allocation process.

FIG. 2D illustrates when the network infrastructure 220 has been modified from the default configuration for remote sessions between the clients 202A-202N and the compute nodes 230A-230N. In at least some embodiments, the session allocation server 206 performs a “clean-up” procedure to restore the default state of the network infrastructure 220 once a corresponding user has disconnected or logged off (i.e., once the modified state is no longer needed). If desired, the default configuration of the network infrastructure 220 can be updated based on recent requests or changes to the network infrastructure 220.

FIGS. 2E-2F show alternative features in accordance with embodiments of the invention. In FIG. 2E, a compute node 230 (e.g., one of the compute nodes 230A-230N) is shown having a plurality of network interfaces 232A-232N. FIG. 2E is provided to clarify that, in some embodiments, a single compute node 230 may have multiple network interfaces 232A-232N. Further, a single compute node 230 may support a plurality of clients 202A-202N. Further, in accordance with FIGS. 2E-2F, a user may connect to compute node 230 via a given VLAN while simultaneously connecting to other network services and devices (e.g., via other VLANs) that are inaccessible from the given VLAN.

In FIG. 2F, a switch port 224 (e.g., one of the switch ports 224A-224N) is shown supporting a plurality of VLANs 222A-222N. FIG. 2F is provided to clarify that, in some embodiments, a single switch port 224 may support a plurality of VLANs 222A-222N.

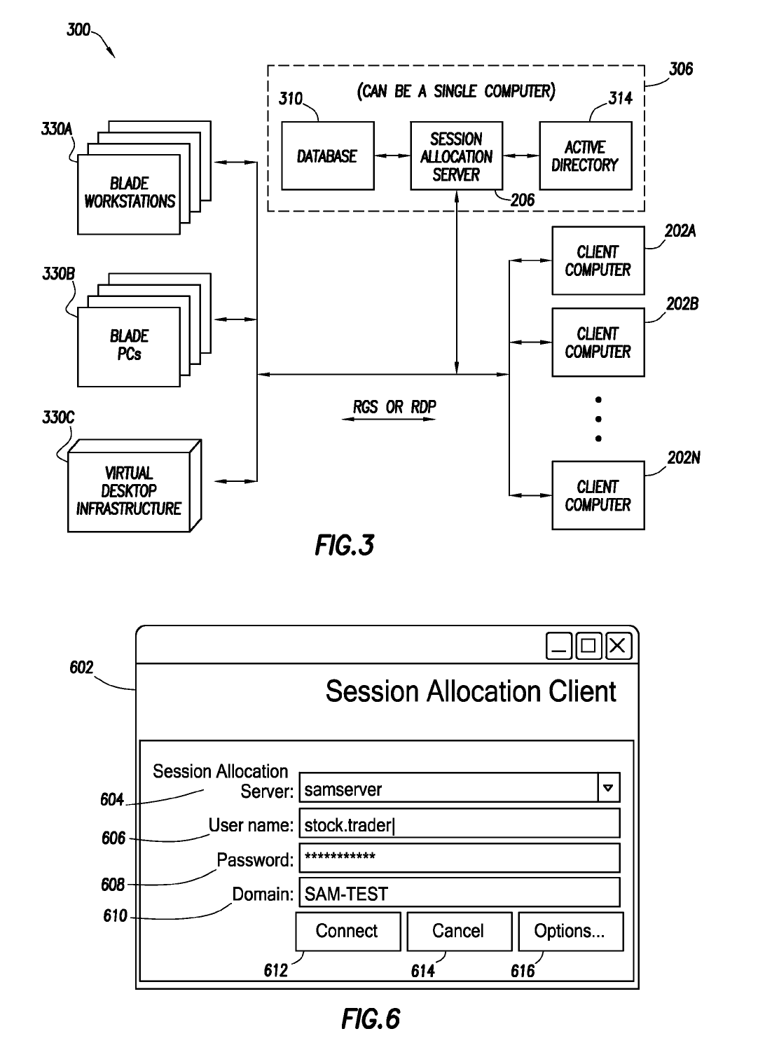

FIG. 3 shows a session-based computer network 300 in accordance with embodiments of the invention. As shown, a plurality of client computers 202A-202N couple to computing resources such as blade workstations 330A, blade personal computers (PCs) 330B and/or a virtual desktop infrastructure 330C via a Remote Graphics Service (RGS) interface and/or a Rapid Deployment Pack (RDP) interface.

In the session-based computer network 300, the session allocation server 206 orchestrates connections between the client computers 202A-202N and the computing resources. When a user requests a connection to a computing resource, the session allocation server 206 accesses a database 310 (e.g., a Structured Query Language (SQL) server or other metadata-based entity) to determine how to allocate the requested computing resources to the user. The database 310 stores information such as the properties of each of the computing resources, including the roles that each computing resource is configured to provide. An example of an administrator-defined role is “stock trader.” In such case, applications specific to the stock-trader role are installed on computing resources that support this role. The database 310 also stores information such as the properties of each of the client computers 202A-202N (e.g., monitor layout, number of monitors, monitor resolution or other properties). The database 310 also stores information such as the RGS properties to use when making an RGS connection (e.g., window borders on/off, image compression level or other properties). The database 310 also may store the user profiles previously discussed. Again, user profiles may include information such as user access rights, user roles (e.g., employee, engineer, marketing), user preferences or other information. Based on the information in the database 310, the session allocation server 206 allocates the computing resources for each user. Upon allocation, the desktop session of one or more computing resources is displayed on the appropriate client computer. In at least some embodiments, session allocation involves re-mapping the network infrastructure 220 (not shown) of the session-based computer network 300.

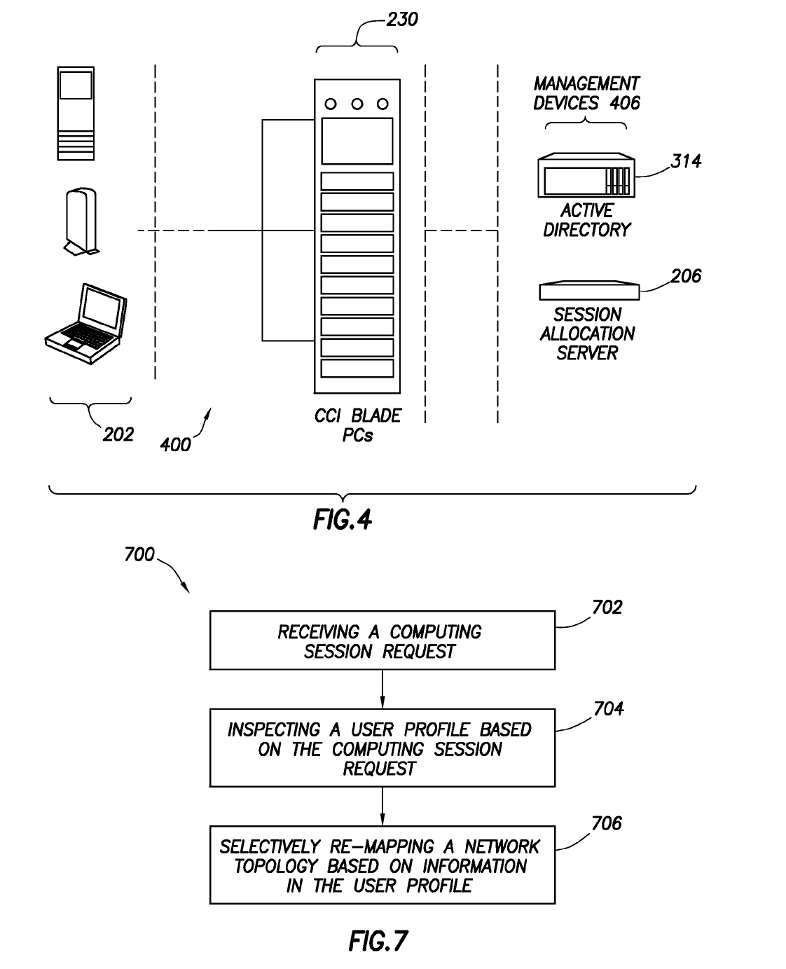

FIG. 4 shows an RCS architecture 400 in accordance with embodiments of the invention. In FIG. 4, a plurality of client computers 202 couple to blade PCs which represent an embodiment of the computing resources 230 previously discussed. The blade PCs may be housed in racks inside of a data center. RCS is a desktop-replacement solution that enables enterprises to enhance data security and business continuity, while lowering total cost of ownership. End users can access their personalized environments, applications and data from almost anywhere, with the same high-level desktop experience. System administrators manage the system using software tools. RCS is similar to server consolidation in that it centralizes resources for better utilization, management and cost savings. In the RCS architecture 400, access, computing and storage are managed from the data center, removing the most vulnerable links in the infrastructure (desktop PCs) and replacing them with Blade PCs stored and managed in the data center.

In the embodiment of FIG. 4, the RCS architecture 400 is managed by a plurality of management devices 406, including a session allocation server 206 and an optional active directory database 314. As understood by those of skill in the art, alternative embodiments could include additional management devices not shown in FIG. 4.

When a user of one of the client computers 202 (e.g., a desktop computer, a notebook computer, or thin client) requests a remote session, the client computer 202 sends a request to the session allocation server 206. In at least some embodiments, the request includes a user name and domain information. If configured, the session allocation server 206 supports server failover. If the session allocation server 206 does not respond, the client computer 202 sends a request to the next session allocation server (not shown) and so on. In other embodiments, the user request may be directed to an alternate session allocation server by a network load balancing device, which removes the need for the client to initiate the second request,

When an operative session allocation server 206 receives user name and domain information from a client computer 202, the session allocation server 206 validates the user name and domain using the active directory database 314. For example, the user's account must be valid and enabled in the active directory database 314 to continue. Upon validation, the session allocation server 206 returns the appropriate desktop session information to the requesting client computer 202. In at least some embodiments, the session allocation server 206 may check its internal database to determine what computing resources 230 are available. Also, prior to assigning a computing resource 230 to a user, the session allocation server 206 may determine whether the user still has a desktop session running and, if so, reconnects the user to the same session (referred to as “follow-me roaming” or “session persistence”). In at least some embodiments, the session allocation server 206 returns a domain name system (DNS) name or IP address to the requesting client computer 202 in response to a successful session request. If no computing resource is available, the session allocation server 206 informs the user with an appropriate message.

Using the DNS name or IP address provided by the session allocation server 206, the client computer 202 is able to connect to the requested desktop session. Before or after allocation of the desktop session, the user may be prompted at a log-in screen to enter a password. In at least some embodiments, the user name and domain are provided by the client computer 202 (i.e., a user does not have to enter them). The session allocation server 206 is able to track when a user logs in and logs out of a session based on a session registration service that runs on the computing resources 230. For example, if a user logs in, the session registration service running on an allocated computer resource 230 reports the log-in to the session allocation server 206. Likewise, if a user disconnects or logs out, the session registration service running on the allocated computer resource 230 reports the disconnection or log-out to the session allocation server 206. The session allocation server 206 uses the information from the session registration service to determine which computer resources 230 are available for allocation.

FIG. 5 shows a remote session administrator interface 502 in accordance with embodiments of the invention. As shown, the session administrator interface 502 displays information to an administrator and enables the administrator to select various options for a network (e.g., the networks 10, 200, 300, 400). For example, an administrator could control user access rights or user roles from the session administrator interface 502. Also, the administrator could limit user preferences from the session administrator interface 502. The various options available to the administrator may be organized with tabs such as a “Home” tab 510, a “Users and Roles” tab 512, a “Resources” tab 514, a “Policies” tab 516, a “System Settings” tab 518, a “Reports” tab 520 and a “Log” tab 522. Under each tab, an administrator may view relevant information and/or select values and options supported by the session allocation server 206. For more information regarding embodiments of a session administrator interface 502 reference may be had to “Administrator's Guide, HP PC Session Allocation Manager (SAM) v 2.0,” published in June 2007, which is herein incorporated by reference.

FIG. 6 shows a remote session client interface 602 in accordance with embodiments of the invention. The session client interface 602 executes on a client computer 202 and enables a user to request a remote session from a client computer 202. As shown, the session client interface 602 may provide a session server line 604, a user name line 606, a password line 608 and a domain line 610. The session client interface 602 also may provide various buttons such as a connect button 612, a cancel button 614 and an options button 616. By accessing the session client interface 602 and providing the appropriate information, users are able to request a remote session. As part of the remote desktop session, the session server 206 allocates computing resources 230 to the user based on user access rights, user roles, user preferences or other information. In at least some embodiments, allocating computing resources 230 involves selectively updating or otherwise changing an existing network topology.

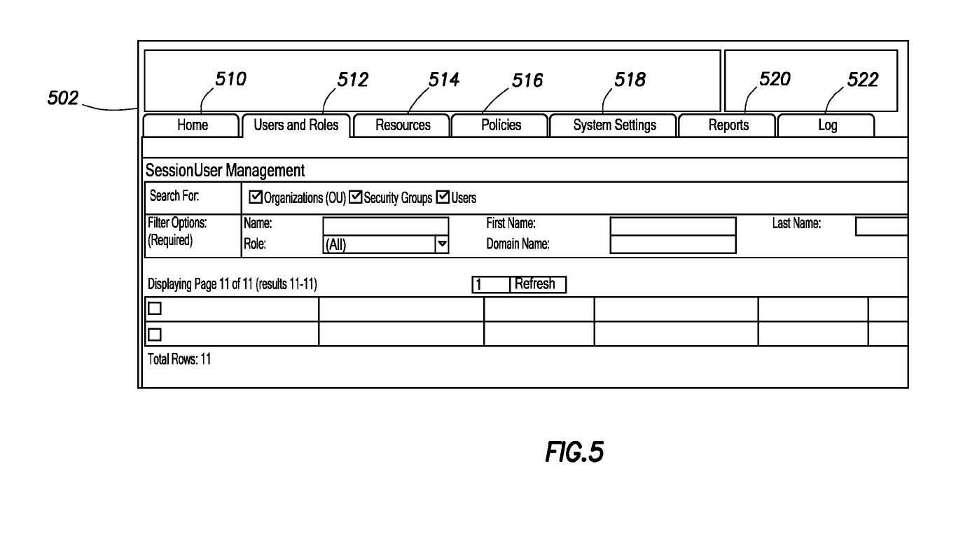

FIG. 7 shows a method 700 in accordance with embodiments of the invention. As shown, the method 700 comprises receiving a computing session request (block 702). The method 700 further comprises inspecting a user profile based on the computing session request (block 704). A network topology is selectively re-mapped based on information in the user profile (block 706). Additionally or alternatively, the current compute resource configuration may be inspected and taken into account when allocating the session.

In various embodiments, the method 700 also comprises additional steps such as re-mapping the network topology by changing at least one Virtual Local Area Network (VLAN) to switch port assignment. Also, the method 700 may comprise customizing the information in the user profile to indicate user access rights to computing resources of a network. Also, the method 700 may comprise customizing the information in the user profile to indicate user preferences for computing resources of a network. Also, the method 700 may comprise connecting a client computer to a compute resource in an RCS architecture after remapping the network topology. Also, the method 700 may comprise connecting a client computer to a virtualized computing resource after remapping the network topology. Also, the method 700 may comprise re-mapping the network topology when users having different roles request computing resources of a network from a single client computer. Also, the method 700 may comprise re-mapping the network topology when a user's role changes.

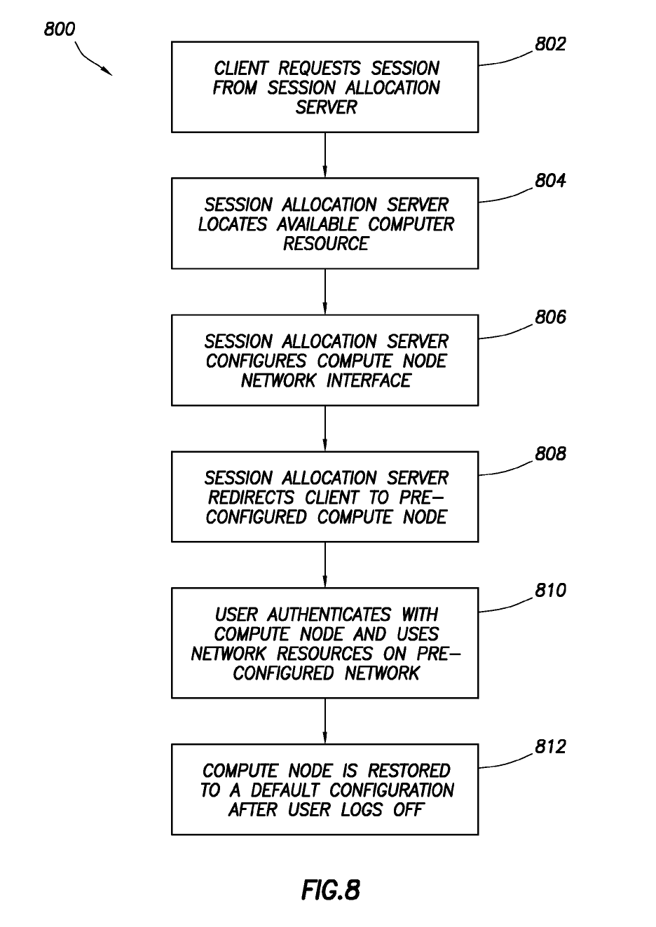

FIG. 8 shows a method 800 in accordance with embodiments of the invention. As shown, the method 800 comprises a client requesting a session from a session allocation server (block 802). The session allocation server locates an available compute resource (block 804). The session allocation server configures a compute node network interface (block 806). The session allocation server re-directs the client to a preconfigured compute node (block 808). The user is authenticated with the compute node and network resources on a pre-configured network (block 810). After the user logs off, the compute node is restored to a default configuration (block 812).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving a remote computing session request;
inspecting a user profile based on the remote computing session request; and
selectively re-mapping a network topology based on information in the user profile.

2. The method of claim 1 wherein re-mapping the network topology comprises changing at least one Virtual Local Area Network (VLAN) to switch port assignment.

3. The method of claim 1 further comprising customizing the information in the user profile to indicate user access rights to computing resources of a network.

4. The method of claim 1 further comprising customizing the information in the user profile to indicate user preferences for computing resources of a network.

5. The method of claim 1 further comprising re-mapping the network topology when users having different roles request remote computing resources of a network from a single client computer.

6. The method of claim 1 further comprising re-mapping the network topology when a user's role changes.

7. A computer network, comprising:
a plurality of client computers;
a plurality of remote computing resources;
a network infrastructure that selectively connects at least one of the client computers to at least one of the remote computing resources; and
a session allocation server coupled to the network infrastructure, the session allocation server selectively customizes the network infrastructure in response to a user requesting a remote computing resource session.

8. The computer network of claim 7 wherein at least one or more of the plurality of remote computing resources comprises virtualized computing resources.

9. The computer network of claim 7 wherein the session allocation server stores a user profile and selectively customizes the network infrastructure based on user access rights indicated in the user profile,

10. The computer network of claim 7 wherein a default configuration of the network infrastructure is restored upon termination of a session.

11. The computer network of claim 7 wherein the session allocation server stores a user profile and selectively customizes the network infrastructure based on user preferences indicated in the user profile.

12. The computer network of claim 7 wherein the session allocation server executes an administrator application that enables a network administrator to set user access rights and user preferences for the computing resources.

13. The computer network of claim 7 wherein each client computer executes a login application that enables different users to request a remote computing resource session.

14. A computer-readable medium comprising software that causes a processor of a computer system to:
receive a request for remote computing resources;
inspect a user profile based on the request; and
selectively change network connections between one or more client devices and one or more remote computing resources based on information in the user profile.

15. The computer-readable medium of claim 14 wherein the software causes the processor to change network connections by re-mapping at least one Virtual Local Area Network (VLAN) to switch port assignment.
